(19) United States
(12) Patent Application Publication
(10) Pub. No.: US 2009/0061978 A1
(43) Pub. Date: Mar. 5, 2009

(54) Real-Time, Online Betting System

(75) Inventor: Eskil Gunnar Ahlin, Veberod (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/848,491

(22) Filed: Aug. 31, 2007

(51) Int. Cl. G06F 17/00

(52) U.S. Cl. 463/16; 463/42

(57) ABSTRACT

A subscriber registers with a betting server. The betting server stores one or more betting preferences for the subscriber. During the sporting event, the betting server receives a real-time event notification responsive to a mini-event within a live sporting event. The betting server generates a betting proposal responsive to said event notification based on the subscriber's betting preferences, and sends the betting proposal to the subscriber.

### BACKGROUND

The present invention relates generally to online betting and, more particularly, to a method of placing and taking bets in real-time during a live broadcast of a sporting event.

Online gambling has gained in popularity over the years. Online gambling includes activities such as online poker, online casinos, online sports betting, and online bingo. With recent improvements in mobile networking technology and mobile device capabilities, there is great interest in making online gambling available to mobile device users. With mobile devices, the subscriber can place bets whenever and wherever he may be. Online gambling would also benefit operators of online gambling sites and betting exchanges by encouraging bettors to place a larger number of bets, and thereby increasing revenues. Event broadcasters would benefit by increased interest in the sporting event.

### SUMMARY OF THE INVENTION

The present invention provides a method of real-time, online sports betting during live sporting events. Within a sporting event, there are numerous “mini-events” that are not scheduled. Such mini-events comprise, for example, a field goal attempt during a football game or penalty kick during a soccer game. Mini-events may take place at any time during the sporting event and the occurrence of such events, by nature, are unpredictable. With the present invention, betting services may generate betting proposals as these mini-events unfold and send the betting proposals in real-time to subscribers.

According to one exemplary embodiment, a subscriber registers with a betting service to receive betting proposals. The subscriber may indicate betting preferences for specific events, which may be stored in a subscriber database. The betting service receives event notifications during the course of a sporting event. In response to the event notifications, the betting service generates and sends betting proposals to the subscriber based on the user's betting preferences.

### BRIEF DESCRIPTION OF THE DRAWINGS

FIG. 1 is a block diagram of a data communications network for online betting.

FIG. 2 is a flow chart illustrating an exemplary method of online betting.

FIG. 3 is a block diagram of an exemplary betting server for online betting.

FIG. 4 illustrates an exemplary online betting scenario.

### DETAILED DESCRIPTION

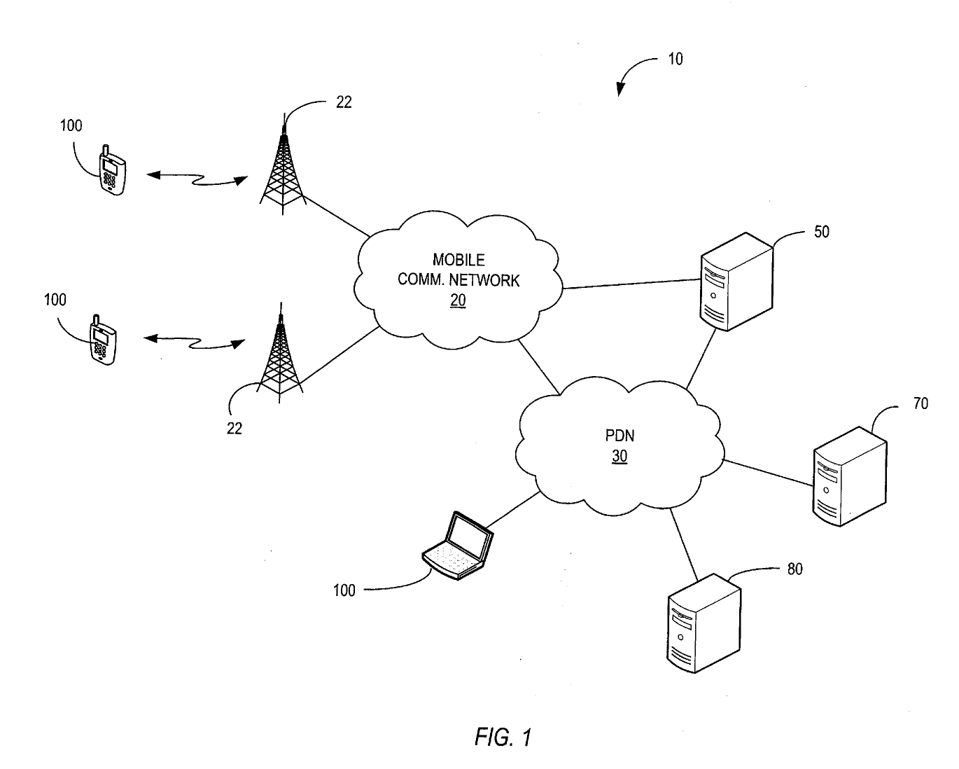

The present invention is described below in the context of a data communications network 10, shown in FIG. 1. The data communications network 10 enables users to place bets on live sporting events. It should be appreciated, however, that the present invention is not limited to any specific type of data communications network or access technology.

Data communications network 10 provides networking capabilities for a plurality of user terminals 100, and comprises a mobile communications network 20 having one or more base stations or wireless access points 22 for communicating with user terminals 100, which may comprise cellular telephones, personal digital assistants, and laptop computers. The mobile communications network 20 provides packet data services to user terminals 100 as is known in the art and may operate according to any conventional standard, such as the GSM, WCDMA, WiFi, WiMAX, and LTE standards. Mobile communication network 20 connects to a Packet Data Network (PDN) 30. PDN 30 comprises a packet-switched network that implements conventional protocols, such as conventional Internet protocols. The PDN 30 may comprise a public or private network, and may be a wide area or local area network. The Internet is one well-known example of a PDN 30. User terminals 100 may also connect to the PDN 30.

A betting server 50 connects to the mobile communication network 20 or PDN 30 and is accessible to the user terminals 100 via the mobile communication network 20 and/or PDN 30. The betting server 50 provides online betting services to subscribers. As will be described in greater detail below, betting server 50 enables subscribers to place bets on unscheduled mini-events that may occur in the course of a sporting event. As a few examples, a subscriber could bet on the outcome of a field goal attempt during a football game, a penalty kick in a soccer game, a penalty shot in a hockey game, or a free throw in a basketball game.

A broadcast server 70 or streaming media server 80 may also connect to the PDN 30 to broadcast or stream video of the sporting events to the user terminals 100. The broadcast server 70 or streaming media server 80 could also be located in the mobile communications network 20. An event broadcaster provides a live video feed to the broadcast server 70 and/or streaming media server 80. In one exemplary embodiment, the broadcast server 70 comprises a Digital Video Broadcast (DVB) broadcasting system. The streaming media server 80 may use known protocols such as the Real-Time Transport Protocol (RTP) or Real-Time Streaming Protocol (RTSP) to stream live video to subscribers. Thus, subscribers may watch live sporting events on their user terminals 100 and place live bets during the sporting event.

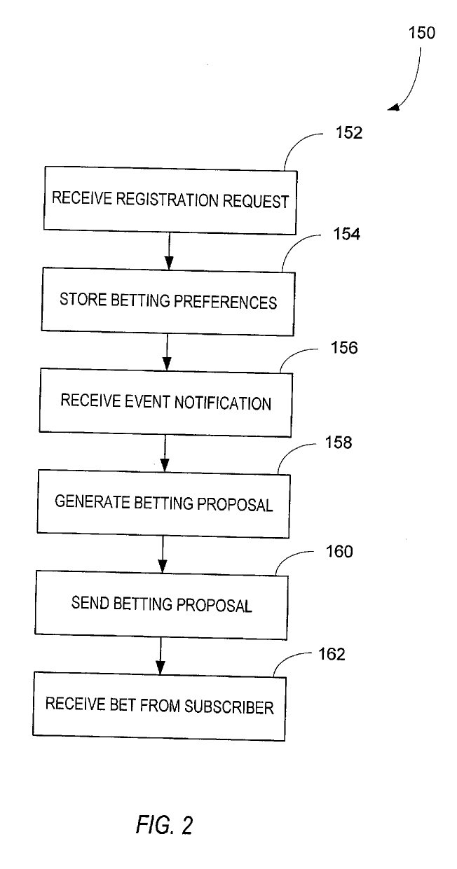

FIG. 2 illustrates a method 150 of real-time, online betting implemented by a betting server 50. The method begins when the betting server 50 receives a registration request from a subscriber to the betting service (block 150). The registration may last a predetermined period of time (e.g. one week, one season, etc.) as specified by the subscriber. During the registration process, the subscriber provides information to the betting server 50, such as the subscriber's name, a subscriber identifier that uniquely identifies the subscriber to the betting server 50, and a subscriber address for sending betting proposals to the subscriber. The subscriber may be required to establish an account with the operator of the betting server 50. The betting operator may assign the subscriber an account number that is linked with the subscriber identifier provided by the subscriber. The subscriber may further provide a method for authentication, such as a password, pin code, or the directory number (e.g., phone number) of the terminal 100 used to place bets, to prevent fraudulent use of the account. The subscriber may also set a default betting amount for bets.

In a preferred embodiment, a subscriber may specify one or more betting preferences. For example, the subscriber may specify a preference for a particular sport (e.g., football, soccer, etc.), a particular sports league (e.g., NFL, NCAA, etc.), a particular conference or division within a league (e.g., NFC, SEC), or a particular team within a league (e.g., Green Bay Packers, Alabama Crimson Tide). The subscriber may also indicate preferences for particular events or particular players or athletes. The subscriber's betting preferences are used by betting server 50 to generate betting proposals tailored to the particular preferences of the subscriber. After the registration process is complete, the subscriber information and betting preferences are stored in a subscriber database (block 154). The subscriber database may be stored in internal memory of the betting server 50, or in a mass storage device connected to the betting server 50.

Based on a subscriber's betting preferences, the betting server 50 generates and sends betting proposals to the subscriber in real-time during live sporting events. The betting proposals are dictated by the course of events in the sporting event. Consider, for example, the sport of football. During a typical football game, each team will have numerous possessions. During each possession, each team will attempt to score, either by moving the ball into the end zone or kicking a field goal. Each possession constitutes a mini-event within the football game. Within each possession, the team in possession will have one or more downs in which to execute plays. Each down or play also constitutes a mini-event. Most mini-events in a football game are not scheduled and, in general, cannot be predicted in advance. Further, certain mini-events in a game, such as a field goal attempt or first down attempt, may have particular significance to the course or outcome of the game.

The mini-events that occur during the course of a larger sporting event present betting opportunities for subscribers. For example, a better may want to wager on the outcome of a particular possession or on a particular play in a football game. Currently, betting operators take bets on the outcome of a sporting event, but do not have means for taking bets on the outcome of mini-events that occur during the sporting event.

According to the present invention, betting server 50 may generate betting proposals in real-time during a live sporting event as the mini-events unfold. The betting proposals may be sent to the user as an inducement to place a bet. The betting operator benefits by encouraging subscribers to place a larger number of bets. Also, the broadcasters and sponsors of the event benefit by increasing viewer interest in the sporting event.

The betting server 50 may arrange to receive event notifications from broadcasters of sporting events. The event notifications may be in a standardized format to enable event processing by a data processor. Event notifications may also be received in the form of user input from a human observer. The betting operator may employ human observers to watch sporting events and generate event notifications through a user interface of the betting server 50.

Returning to FIG. 2, betting server 50 receives event notifications from either the broadcaster or human observer during the course of a sporting event (block 156). When an event notification is received, the betting server 50 determines whether to generate a betting proposal for a particular subscriber based on the subscriber's betting preferences. For example, if the subscriber indicates a team preference, the betting server 50 may generate betting proposals only for games in which the preferred team is a participant. Betting server 50 filters the events based on the subscriber's betting preferences and selects those events that match the subscriber's betting preferences. The betting server 50 generates a betting proposal including the specific mini-event and odds set by the betting operator (block 158). If the subscriber has set a default bet amount for mini-events, the betting proposal may further include the default bet amount.

The betting proposal may be generated and sent during a stoppage in play. For example, a timeout may be called immediately before a team attempts a field goal during a game. During the time-out, the betting server 50 may generate the betting proposal (block 158) and send the betting proposal to the subscriber (block 160). The subscriber may be given a limited period of time in which to respond to the betting proposal. The betting server 50 may also send the betting proposal to the event broadcaster, so that the betting proposal may be broadcast along with the event to viewers during the break in play (block 160).

The betting server 50 sends or pushes the betting proposals to the subscriber address provided by the subscriber during registration (block 160). Preferably, the betting proposals are sent in a standard messaging format that does not require any special software on the user terminal 100. The betting proposal may, for example, comprise a WAP PUSH message, an SMS message, an MMS message, a SIP message, or an email message. The betting proposal contains a description of the event and the odds for the outcome. Thus, the subscriber does not need to watch the event in order to receive betting proposals. The betting server 50 may include in the betting proposal a link to a broadcast server 70 or streaming server 80 to make it more convenient for the subscriber to watch the event.

In response the betting proposal, the subscriber may decide to place a bet (block 162). The subscriber may place a bet in any one of a number of ways. If SMS or other text messaging service is used to send betting proposals, the user may place a bet by entering predetermined text in a reply to the message. The message may include interactive elements, such as buttons and text boxes, to enable users to more easily place bets. For example, the message may include a text box for entering the amount of a bet and buttons to accept and/or decline the bet. The betting proposal may also include a link to a secure website that may be accessed by the subscriber to place bets. The DVB protocol includes interactive mechanisms. If the user is watching the sporting event, the user may place bets using the interactive protocols in the DVB protocol. When placing bets, the subscriber may be required to enter the password or pin code provided by the user during registration to prevent fraudulent use of the subscriber's account. The betting proposals and responses may also be encrypted to prevent eavesdropping. As bets are placed, betting server 50 maintains a record of the bets and credits or debits the subscriber's account, depending on the outcome of the events.

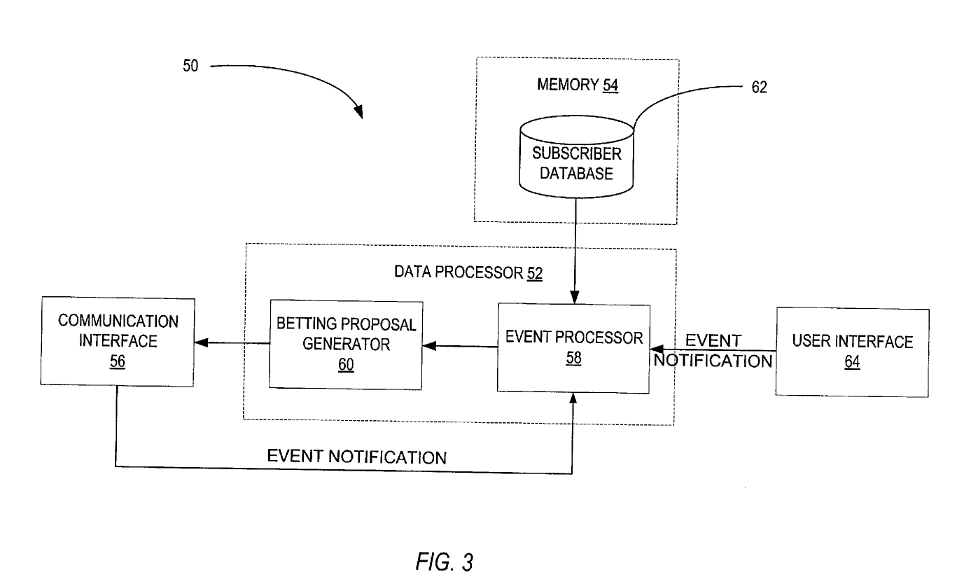

FIG. 3 illustrates an exemplary betting server 50. The betting server 50 comprises a data processor 52, memory 54, a communication interface 56, and a user interface 64. The data processor 52 may comprise one or more microprocessors, microcontrollers, hardware circuits, and/or a combination thereof. An event processor 58 in data processor 52 receives event notifications and filters the events based on the subscriber's betting preferences as previously described. Qualifying events are passed to a betting proposal generator 60 in the data processor 52 to generate and send betting proposals to the user.

Memory 54 stores data and programs needed by the data processor 52. A subscriber database 62 is stored in memory 54. Memory 54 may comprise one or more discrete memory devices, such as random access memory, read-only memory, and flash memory. Memory 54 may further include one or more mass storage devices, such as magnetic or optical disk drives.

Communications interface 56 connects the betting server 50 to the packet data network 30. The betting server 50 sends betting proposals and receives betting responses through the communication interface 56. Further, the betting server 50 may receive event notifications over the communications interface 56. Alternatively, the betting server 50 may receive event notifications via user interface 64. The communication interface 56 may comprise, for example, an Ethernet interface, cable modem, or DSL interface.

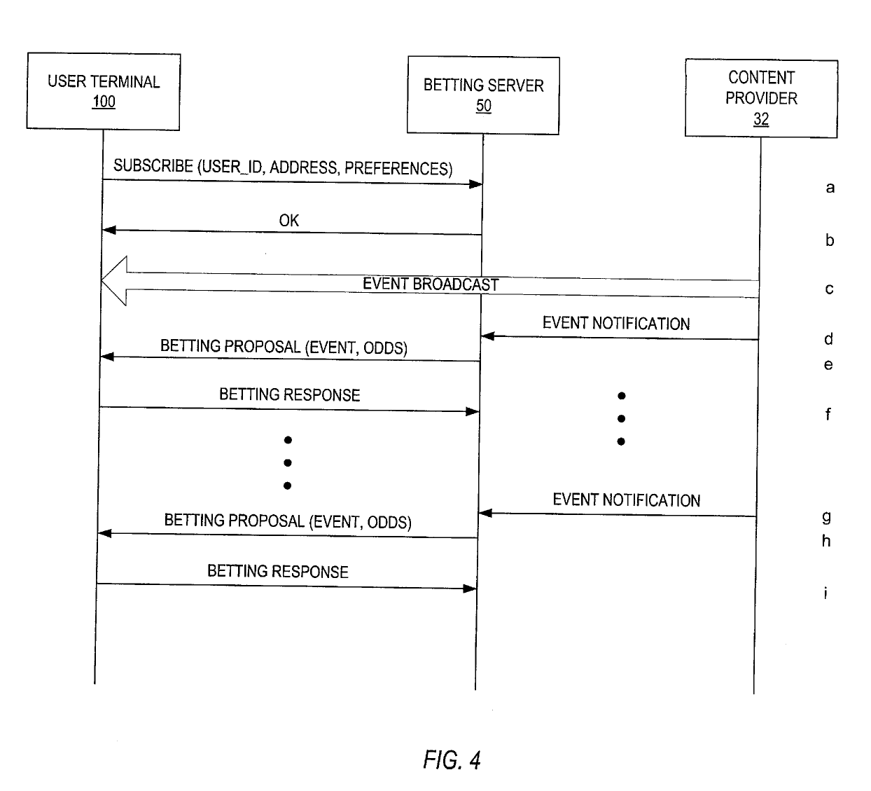

FIG. 4 illustrates one exemplary scenario for on-line gaming according to the present invention. A subscriber registers with the betting server 50 by sending a subscription request to the betting server 50 (step a). The subscription request includes a subscriber identifier (ID), subscriber address, and one or more subscriber preferences. The subscriber ID uniquely identifies the subscriber to the betting server 50. The subscriber address specifies the address used by the betting server 50 to send betting proposals. The betting preferences are used in the generation of betting proposals as previously described. After verifying the subscriber information, the betting server 50 sends an acknowledgement to the subscriber (step b). The acknowledgement indicates to the subscriber that the subscription was successful.

When a sporting event begins, the event broadcaster may broadcast or stream the sporting event to the subscriber via a broadcast server 70 or streaming media server 80 (step c). In the alternative, the subscriber may view the sporting event a separate device, such as a television. It is not required that the subscriber receive or watch the sporting event in order to place bets. The betting server 50 may generate and send betting proposals to the user even when the user is off-line.

During the course of the event, the event broadcaster sends notifications of mini-events to the betting server 50 (steps d, g). Some of the mini-events may be of interest to the subscriber. In response to the event notification, the betting server 50 compares the events identified in the event notification to the subscriber's betting preferences. If the particular event is determined to be relevant to a particular subscriber, the betting server 50 generates and sends a betting proposal to the subscriber (steps e, h). The subscriber may place a bet by sending a betting response to the betting proposal (steps f, i). The absence of a reply will be treated by the betting server 50 as a rejection of the betting request. As bets are placed, the betting server 50 maintains a record of the bets and credits or debits the subscriber's account, depending on the outcome of the event.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of online betting comprising:
storing one or more betting preferences for a subscriber;
receiving a real-time event notification responsive to a mini-event within a live sporting event;
generating a betting proposal responsive to said event notification based on said stored betting preference(s); and
sending said betting proposal to said subscriber.

2. The method of claim 1 wherein said betting preferences includes at least one of a team preference, a sport preference, a player preference, and an event preference.

3. The method of claim 1 wherein receiving a real-time event notification comprises receiving said event notification from an event broadcaster.

4. The method of claim 1 wherein receiving a real-time event notification comprises receiving input from a user interface.

5. The method of claim 1 wherein said betting proposal includes a link to allow said subscriber to view said event or said mini-event.

6. The method of claim 1 wherein said betting proposal includes odds associated with said mini-event.

7. The method of claim 6 further comprising sending said betting proposal to an event broadcaster for re-broadcast to viewers of the sporting event.

8. The method of claim 1 wherein sending said betting proposal to said subscriber comprises sending a formatted message containing said betting proposal to said subscriber.

9. The method of claim 8 wherein said formatted message comprising one of an SMS, MMS, email, SIP, and instant message.

10. The method of claim 8 wherein said formatted message includes an active component for placing bets responsive to said betting proposal.

11. The method of claim 8 wherein said betting proposal includes a link to an online betting site for placing bets.

12. An online betting server comprising:
memory storing one or more betting preferences for a subscriber; and
an application server configured to:
receive a real-time event notification responsive to a mini-event within a live sporting event;
generate a betting proposal responsive to said event notification based on said stored betting preference(s); and
send said betting proposal to said subscriber.

13. The online betting server of claim 12 wherein said betting preferences include at least one of a team preference, a sport preference, a player preference, and an event preference.

14. The online betting server of claim 12 wherein said application server receives said event notification from an event broadcaster.

15. The online betting server of claim 12 wherein said application server receives said event notification from an observer.

16. The online betting server of claim 12 wherein said betting proposal includes a link to allow said subscriber to view said event or said mini-event.

17. The online betting server of claim 12 wherein said betting proposal includes odds associated with said mini-event.

18. The online betting server of claim 17 wherein said application server is further configured to send said betting proposal to an event broadcaster for re-broadcast to viewers of the sporting event.

19. The online betting server of claim 12 wherein said application server sends said betting proposal to said subscriber in a formatted message.

20. The online betting server of claim 19 wherein said formatted message comprising one of an SMS, MMS, email, SIP, and instant message.

21. The online betting server of claim 19 wherein said formatted message includes an active component for placing bets responsive to said betting proposal.

22. The online betting server of claim 19 wherein said betting proposal includes a link to an online betting site for placing bets.
